(19) United States
(12) Patent Application Publication
(10) Pub. No.: US 2025/0341807 A1
(43) Pub. Date: Nov. 6, 2025

(54) DIGITAL TO TIME CONVERTER

(71) Applicant: Intel Corporation, Santa Clara, CA (US)

(72) Inventors: Rotem BANIN, Even Yehuda (IL); Anna NAZIMOV, Haifa (IL); Elan BANIN, Raanana M (IL); Assaf BEN-BASSAT, Haifa (IL); Yishai EILAT, Alonei Aba (IL); Ofir DEGANI, Haifa (IL)

(21) Appl. No.: 18/655,228

(22) Filed: May 4, 2024

(51) Int. Cl. G04F 10/00

(52) U.S. Cl. CPC G04F 10/00

(57) ABSTRACT

A digital to time convertor includes a frequency division stage, configured to generate a first frequency output based on a first instruction set and a second frequency output based on a second instruction set; a delay stage, configured to generate a first delayed frequency output and a second delayed frequency output based on the first frequency output, and to generate a third delayed frequency output and a fourth delayed frequency output based on the second frequency output; a selection stage, configured to output one of the first delayed frequency output or the third delayed frequency output based on a control code; and to output one of the second delayed frequency output, the second frequency output, the first frequency output, or the fourth delayed frequency output based on the control code; and a signal generator, configured to generate an interpolated signal based on the output of the selection stage.

### TECHNICAL FIELD

Various aspects of this disclosure generally relate to the generation of a signal having a desired frequency. In particular, aspects of the disclosure generally relate to a digital to time converter (DTC) for such frequency creation, wherein the resulting division ratio is less than two.

### BACKGROUND

Digital to time converters are meaningful elements in signal modulation. Some DTCs achieve coarse modulation of the signal using frequency dividers to create the desired signal; however, this limits the DTC's maximum output frequencies to half of the DTC's input clock, as this represents the maximum sampling frequency of the frequency dividers.

Pushing the output frequency higher would require an increase of the DTC clock, which in turn would cause timing limitations on the DTC implementation.

### BRIEF DESCRIPTION OF THE DRAWINGS

In the drawings, like reference characters generally refer to the same parts throughout the different views. The drawings are not necessarily to scale, emphasis instead generally being placed upon illustrating the exemplary principles of the disclosure. In the following description, various exemplary embodiments of the disclosure are described with reference to the following drawings, in which:

FIG. 1A depicts a high-level or abstracted view of a high-band DTC;

FIG. 1B depicts exemplary component signals for generating a single frequency edge;

FIG. 2 depicts additional details of the DTC of FIG. 1A;

FIG. 3 depicts a state machine for the positioning of the edge of a gated multi modulus divider (MMD);

FIG. 4 depicts an alternative, 3-node state machine;

FIG. 5 depicts an alternative implementation in which the selectors are replaced by two additional MMDs;

FIG. 6 depicts an example of the creation of signal “I” as depicted in FIG. 5; and

FIG. 7 depicts a DTC convertor.

### DESCRIPTION

The following detailed description refers to the accompanying drawings that show, by way of illustration, exemplary details and embodiments in which aspects of the present disclosure may be practiced.

The word “exemplary” is used herein to mean “serving as an example, instance, or illustration”. Any embodiment or design described herein as “exemplary” is not necessarily to be construed as preferred or advantageous over other embodiments or designs.

Throughout the drawings, it should be noted that like reference numbers are used to depict the same or similar elements, features, and structures, unless otherwise noted.

The phrase “at least one” and “one or more” may be understood to include a numerical quantity greater than or equal to one (e.g., one, two, three, four, [ . . . ], etc.). The phrase “at least one of” with regard to a group of elements may be used herein to mean at least one element from the group consisting of the elements. For example, the phrase “at least one of” with regard to a group of elements may be used herein to mean a selection of: one of the listed elements, a plurality of one of the listed elements, a plurality of individual listed elements, or a plurality of a multiple of individual listed elements.

The words “plural” and “multiple” in the description and in the claims expressly refer to a quantity greater than one. Accordingly, any phrases explicitly invoking the aforementioned words (e.g., “plural [elements]”, “multiple [elements]”) referring to a quantity of elements expressly refers to more than one of the said elements. For instance, the phrase “a plurality” may be understood to include a numerical quantity greater than or equal to two (e.g., two, three, four, five, [ . . . ], etc.).

The phrases “group (of)”, “set (of)”, “collection (of)”, “series (of)”, “sequence (of)”, “grouping (of)”, etc., in the description and in the claims, if any, refer to a quantity equal to or greater than one, i.e., one or more. The terms “proper subset”, “reduced subset”, and “lesser subset” refer to a subset of a set that is not equal to the set, illustratively, referring to a subset of a set that contains less elements than the set.

The term “data” as used herein may be understood to include information in any suitable analog or digital form, e.g., provided as a file, a portion of a file, a set of files, a signal or stream, a portion of a signal or stream, a set of signals or streams, and the like. Further, the term “data” may also be used to mean a reference to information, e.g., in form of a pointer. The term “data”, however, is not limited to the aforementioned examples and may take various forms and represent any information as understood in the art.

The terms “processor” or “controller” as, for example, used herein may be understood as any kind of technological entity that allows handling of data. The data may be handled according to one or more specific functions executed by the processor or controller. Further, a processor or controller as used herein may be understood as any kind of circuit, e.g., any kind of analog or digital circuit. A processor or a controller may thus be or include an analog circuit, digital circuit, mixed-signal circuit, logic circuit, processor, microprocessor, Central Processing Unit (CPU), Graphics Processing Unit (GPU), Digital Signal Processor (DSP), Field Programmable Gate Array (FPGA), integrated circuit, Application Specific Integrated Circuit (ASIC), etc., or any combination thereof. Any other kind of implementation of the respective functions, which will be described below in further detail, may also be understood as a processor, controller, or logic circuit. It is understood that any two (or more) of the processors, controllers, or logic circuits detailed herein may be realized as a single entity with equivalent functionality or the like, and conversely that any single processor, controller, or logic circuit detailed herein may be realized as two (or more) separate entities with equivalent functionality or the like.

As used herein, “memory” is understood as a computer-readable medium (e.g., a non-transitory computer-readable medium) in which data or information can be stored for retrieval. References to “memory” included herein may thus be understood as referring to volatile or non-volatile memory, including random access memory (RAM), read-only memory (ROM), flash memory, solid-state storage, magnetic tape, hard disk drive, optical drive, 3D XPoint™, among others, or any combination thereof. Registers, shift registers, processor registers, data buffers, among others, are also embraced herein by the term memory. The term “software” refers to any type of executable instruction, including firmware.

Unless explicitly specified, the term “transmit” encompasses both direct (point-to-point) and indirect transmission (via one or more intermediary points). Similarly, the term “receive” encompasses both direct and indirect reception. Furthermore, the terms “transmit,” “receive,” “communicate,” and other similar terms encompass both physical transmission (e.g., the transmission of radio signals) and logical transmission (e.g., the transmission of digital data over a logical software-level connection). For example, a processor or controller may transmit or receive data over a software-level connection with another processor or controller in the form of radio signals, where the physical transmission and reception is handled by radio-layer components such as RF transceivers and antennas, and the logical transmission and reception over the software-level connection is performed by the processors or controllers. The term “communicate” encompasses one or both of transmitting and receiving, i.e., unidirectional or bidirectional communication in one or both of the incoming and outgoing directions. The term “calculate” encompasses both ‘direct’ calculations via a mathematical expression/formula/relationship and ‘indirect’ calculations via lookup or hash tables and other array indexing or searching operations.

It is known to implement a DTC, wherein outputs of the divider stage are sampled by flip flops, which can essentially generate a signal with minimum division ratio of two. Although a lower division ratio can sometimes be generated briefly, it cannot be sustained over a long period, which may be necessary or desirable in certain implementations. To solve this problem, it is also known to combine the signals of two DTCs to form a single output at a double rate leading to a division ratio of 1. The problem with this strategy is that it achieves a sustainable divisional ratio of less than 2 at the expense of requirement more than double the area and power of other conventional DTC solutions. Moreover, this dual-DTC strategy may be undesirable in certain circumstances, since finite isolation and mismatch can result in some of the DTC signal coupling to the accompanying XOR output, thereby creating a half-frequency spur, which in turn may result in regulatory problems for the transmitter. Efforts to limit this effect have required a complicated calibration scheme and calibration circuits, thereby adding more area and power requirements to the system.

As described herein, two multi modulus dividers (MMDs) can be used to generate signals based on a digital input, and these signals can be combined to create a minimum division ratio of 1.5, while still using a single interpolation stage. This saves area and power compared to other existing efforts to implement a DTC with a division ratio of less than two. Moreover, this strategy avoids the half-frequency spur altogether.

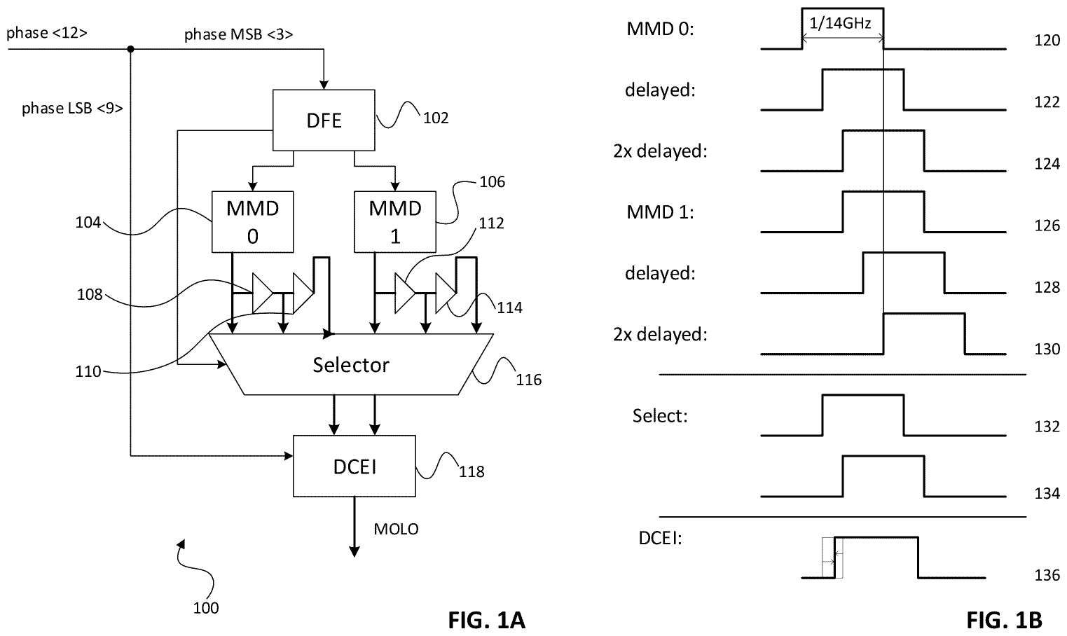

FIG. 1A depicts a high-level or abstracted view of a high-band DTC 100 that can generate a modulated, local oscillator (LO) signal (“modulated local oscillator” is referred to herein as “MOLO”), without requiring a frequency doubler. The DTC 100 may include a digital front end 102, which may be configured to generate digital signals to control the multi-modulus dividers and selector, as will be described in greater detail.

The DTC 100 may further include a first multi-modulus divider (MMD) 104 and a second MMD 106. An MMD may be understood as a device to perform division by multiple divisors. The MMD may be capable (whether individually or as part of a greater combination of devices) of generating a signal with a precise frequency based on a digital input. Each MMD may output up to a 7 GHz modulated clock with a resolution of 180°. There may be a 90° offset between the MMDs driven from a 14 GHz clock.

The DTC 100 may further include four delay lines, two of which may be connected to each of the MMDs. For example, MMD 0 104 is connected to first delay line 108 and second delay line 110, and MMD 1 106 is connected to third delay 112 and forth delay the 114. Each delay line may be configured to output a 45° delay/offset relative to its input. For example, first delay 108 will receive an input signal from MMD 0 104, and will delay this input signal by 45°. The second delay 110 will receive the output signal of first delay 108 and will delay this signal by a further 45°, thereby making an output of the second delay 110 90° delayed from the output of MMD 0 104. Similarly, third delay 112 will receive an input signal from MMD 1 106, and will delay this input signal by 45°. The fourth delay 114 will receive the output signal of the third delay 112, and will delay this signal by a further 45°, thereby making an output of the fourth delay 114 90° delayed from the output of MMD 1 106.

The DTC 100 may further include a Selector 116, which may be configured to provide the relevant signals (e.g. for each MMD, either the signal from the MMD, or the signal from one of the two corresponding delays connected to the MMD), to a digital clock edge interpolator (DCEI). The selector may receive control signals directly from the DFE 102, wherein the control signals indicate to the selector which of the input signals (e.g. MMD signals or delay signals) should be output to the DCEI. Of note, the selector 116 will output one of the MMO 0 104 output, the output of the first delay 108 or the output of the second delay 110, as well as one of the MMD 1 106 output, the output of the third delay 112, or the output of the fourth delay 114.

The DTC 100 may further include the DCEI 118, which may be configured to interpolate two edges from the above signals received as its input signals. This interpolation may achieve an output signal having an accurate phase resolution (with-in the 45° range).

FIG. 1B shows the components with an example of the signals generating a single MOLO edge. In 120, the output of MMD 0 104 is depicted. This output illustratively corresponds to a frequency of 14 GHz or 71.4285714 ps (this is provided as an example; any other frequency may be selected). In 122, the output of the first delay 108 is depicted. This shows the signal of 120, shifted 45°. In 124, the output of the second delay 110 is depicted. This shows the signal of 122, shifted 45°. In 126, the output of MMD 1 106 is depicted. This output also illustratively corresponds to a frequency of 14 GHz or 71.4285714 ps (this is also provided as an example; any other frequency may be selected). In 128, the output of the third delay 112 is depicted. This shows the signal of 126, shifted 45°. In 130, the output of the second delay 114 is depicted. This shows the signal of 128, shifted 45°. Of note, because the output of MMD 1 106 is 90° shifted from the output of MMD 0 104, the output of the second delay 110 is equivalent or essentially equivalent to the output of MMD1 106.

Depending on the system requirements of the digital instructions received, it may be necessary for the DTC to perform one or more negative phase jumps (e.g. generation of a signal having a reduced phase shift compared to the phase shift of the last signal generated). In order to allow for such negative phase jumps (e.g., compressed period higher instantaneous frequency), the DTC uses two parallel-MMDs (e.g. 104 and 106) as described herein. Because each MMD covers a different phase range, any phase jump from −90° to +180° can be supported.

Each MOLO edge (both rising and falling) may be generated from one of the MMDs (e.g. MMD 0 104 and MMD 1 106), according to the most significant bit(s) (MSB) of the phase-code. That is, the digital instructions to the DFT for signal generation may include a phase code. Each MMD output is shifted twice (e.g. using the corresponding to delays), to obtain three versions with 45° (˜18 ps) delay between them. The selector may select, for example, two neighboring versions (45° apart) from the same MMD, to be interpolated in the DCEI. The DCEI may uses the LSBs of the phase code to interpolate between the two edges.

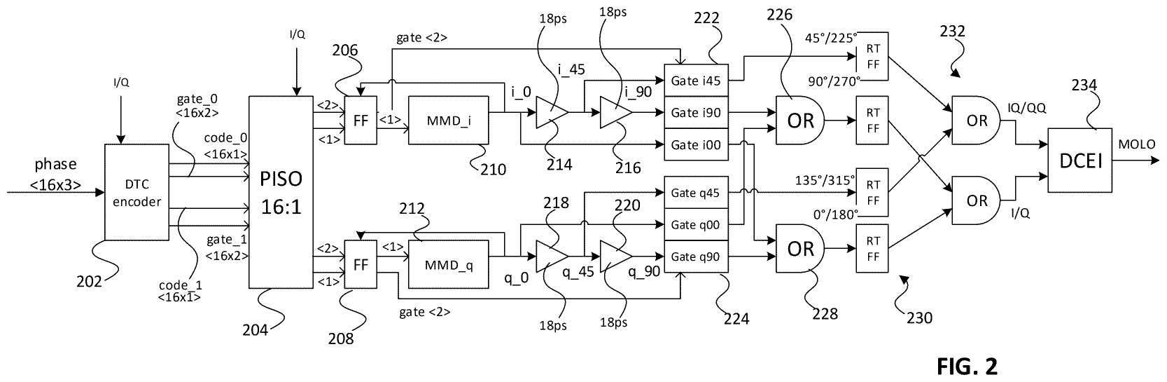

FIG. 2 depicts additional details of the DTC of FIG. 1A. In FIG. 2, the DTC encoder 202 receives phase information regarding a desired output signal and in turn outputs corresponding codes signals and gate signals. Specifically, the DTC encoder 202 may output code_0, which may be understood as a control code for MMD 0 (depicted herein alternatively as MMD_i) and output code_1, which may be understood as a control code for MMD 1 (depicted herein alternatively as MMD_q). The DTC encoder 202 may also be configured to output gate signal 0 (gate_0), configured to control gates related to MMD 0 (e.g. MMD_i), and to output gate signal 1 (gate_1), configured to control gates related to MMD 1 (e.g. MMD_q). The DTC encoder may be configured in hardware or software. In one configuration, the DTC encoder 202 may be configured as hardware. In another configuration, the DTC encoder 202 may be configured as computer readable instructions configured to cause a processor, when executed, to perform the descriptions of the DTC encoder 202 included herein. In another configuration, the DTC encoder 202 may be configured as a processor configured to execute these instructions. The DTC encoder may be is synced to an I/Q clock (MOLO rate). Each MOLO edge may require its own set of commands. The DTC encoder may be configured to perform these calculations in parallel (e.g., clock divided by 16) to meet timing requirements.

The DTC may be configured with a parallel-in-serial-out (PISO) component 204, which may be configured to receive the output signals of the DTC encoder 202 and to output them in serial format.

The DTC may be further configured with a first flip-flop 206 and a second flip-flop 208. The first flip-flop 206 may sample an output of the MMD 0 (e.g. MMD_i), and the second flip-flop 208 may sample an output of the MMD1 (e.g. MMD_q).

The DTC may include a first MMD (e.g. MMD_i) 210 and a second MMD (e.g. MMD_q) 212. As described above, each of the two MMDs may be configured to generate a signal based on a received code. Each of these MMDs may be configured to operate in its own clock-domain (e.g., its output clock may toggle the input-code for the MMD counter and gates). Each of these MMDs may be configured to generate signals having a phase difference of 90° from one another. Each MMD may be configured to sample the data in its own clock domain. In some cases, an MMD will “skip a line” in the PISO (because I/Q clock can have more edges than an MMD). This is expected and is planned for in the DFE.

The “selector” of the FIG. 1A may be implemented with gating blocks and OR gates (e.g. for example instead of using a multiplexer, although a multiplexer could alternatively be used), for a simpler design. FIG. 2 depicts a configuration using multiple gates as the selector. In this configuration, the output of MMD_i 210 is delayed by a first delay 214 and a second delay 216. Similarly, the output of MMD_q 212 is delayed by a third delay 218 and forth delay 220. A first gate array 222 receives the signals of MMD_i 210, the first delay 214 and the second delay 216, as well as a gate control signal generated by the DTC encoder 202. A second gate array 224 receives the signals of MMD_q 212, the third delay 218 and the fourth delay 218, as well as a gate control signal generated by the DTC encoder 202. Using the respective gate control signals, the data raise 222 and 224 allow one or more selected signals to pass through to the logic array.

The logic array is depicted herein as including first OR-gate 226 and second OR-gate 228, as well as a flip-flop array 230, and finally an OR-gate array 232 including a third OR-gate and a fourth OR-gate. In this manner, the DCEI 234 generates an interpolated signal from the signals it receives from the OR-gate array 232. As depicted herein, the DCEI 234 may receive from the first OR-gate (e.g. the top OR-gate of 232) any one of the 45°-shifted signal of the MMD_i 210 from the first delay 214 or the 45° shifted signal of the MMD_q 212 from the third delay 218. Similarly, the DCEI 234 may receive from the second OR-gate 228 any one of the 90° delayed signal of the MMD_i 210 from the second delay 216, the output of the MMD_q 212, the output of the MMD_i 210, or the 90° delayed signal of the MMD_q 212 from the fourth delay 220. Similar to that depicted in FIG. 1B, the DCEI 234 then interpolates a new signal from the rising and falling edges of the signals received from the OR-gates.

The DTC encoder 202 may determine codes for each of the first MMD 210, the second MMD 212, and the gates based on the three MSBs of the phase code. As part of this determination, the DTC encoder 202 must determine which MMD to use, in which gate to use for the resulting MMD signal. The DTC encoder 202 makes this determination by analyzing the middle phase bit out of the three and MSBs. Each MMD covers a different phase range. If the middle phase bit is 0 (e.g., indicating a phase between 0° and) 90°, the DTC encoder 202 uses MMD i, whereas, if the middle phase bit is 1 (e.g., indicating a phase between 90° and 180°), the DTC encoder 202 uses MMD_q.

The DTC encoder 202 must also determine which delayed versions to use. This is achieved by analyzing the least significant bit (LSB) of the phase code. If the LSB is 0 (e.g. indicating a phase between 0° and) 45°, the DTC encoder 202 uses i_0 and i_45 (or q_0 and q_90). If the LSB is 1 (e.g., indicating a phase between 45° and) 90°, the DTC encoder 202 uses i_45 and i_90 (or q_45 and q_90).

The DTC encoder 202 must also determine the appropriate jump for the active MMD (e.g. whether the first MMD 210 or the second MMD 212). The DTC encoder 202 determines the active MMD jump based on the position of the active MMD's previous edge and the MSB, as will be described in greater detail below. Relatedly, the DTC encoder 202 must also determine the appropriate jump for the gated MMD. Even though the edge of the gated MMD is not used by the DCEI 234, the edge of the gated MMD must be positioned in such a way that it can be used to support the next edge, if necessary. For this, the best option is to locate the MMD's edge 90° before the active edge (e.g., the edge from the non-gated MMD), which allow the gated MMD to then support any next phase to come. Under some circumstances, this will not be possible; as such, the best course of action is depicted in terms of a state machine.

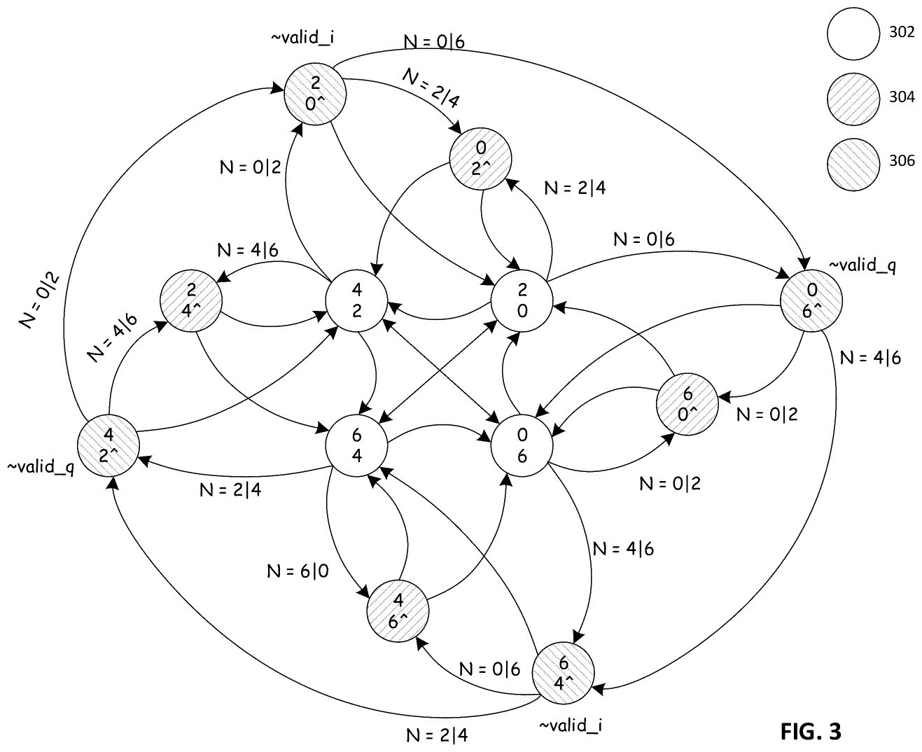

FIG. 3 depicts a state machine for the positioning of the edge of the gated MMD. Each node represents the previous phase of each MMD. The numbers are the 3 MSBs (discarding the LSB, which does not affect the state-machine, this leaves 0, 2, 4, and 6). The upper number corresponds to the last active MMD, and the lower number corresponds to the gated MMD. Each new phase can change the state according to the arrows. The phase is not written on the arrows, but it can be deduced from the target node's upper number. For example, if a state is (4, 2), and a ‘6’ is obtained, the state machine can go to (6,4), which is the only neighboring node with ‘6’ at the top.

The numbers on the arrows indicated by “N” represent a next phase. In some cases, the current phase can go to more than one node, and the next node is then decided by the next phase. For example, the state machine is at (4, 2), and a ‘2’ is obtained, the state machine can go either to (2, 0\hat{ }) or to (2, 4\hat{ }). If the next phase is 0 or 2, the state machine can go to (2,0\hat{ }) or (2,4\hat{ }). Note that the ‘\hat{ }’ symbol represents the gated edge being after (later than) the active edge.

The nodes are coded as unshaded 302, shaded with rising lines 304, or shaded with falling lines 306. The unshaded 302 states can go to themselves. The rising lines 304 indicate a kind of instability or loss of flexibility in the availability of subsequent nodes, and such nodes will attempt to return to an unshaded node. The nodes marked by falling lines 306 indicate further increased instability or inflexibility, and the state machine will attempt to transfer from these nodes to an unshaded node, where possible, although transition to a node marked by rising lines 304 or even another node marked by falling lines 306 is conceivable.

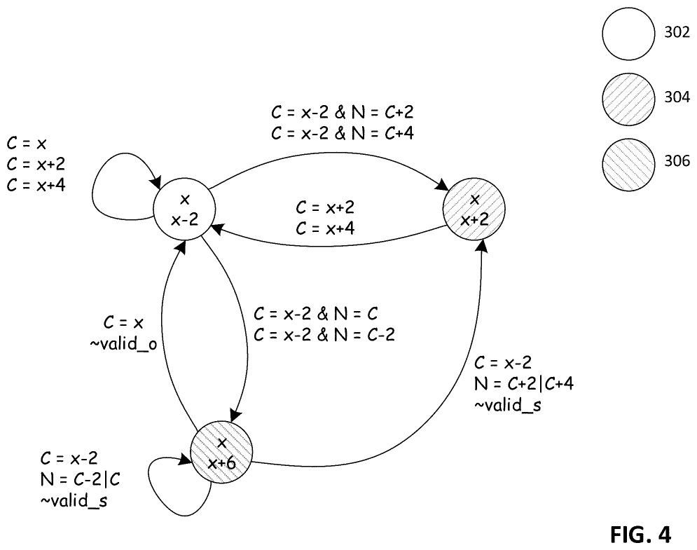

Of note, the state machine is 4-ways-symmetric, meaning that it can be shrunk down to a 3-node state machine, where each node represents multiple phases. FIG. 4 depicts this alternative, 3-node state machine. As in the previous figure, the nodes are indicated as being unshaded 302, shaded with rising lines 304, or shading with falling lines 306. In this figure, the gated MMD phase is noted relative to the active MMD (e.g. x−2 relative to x).

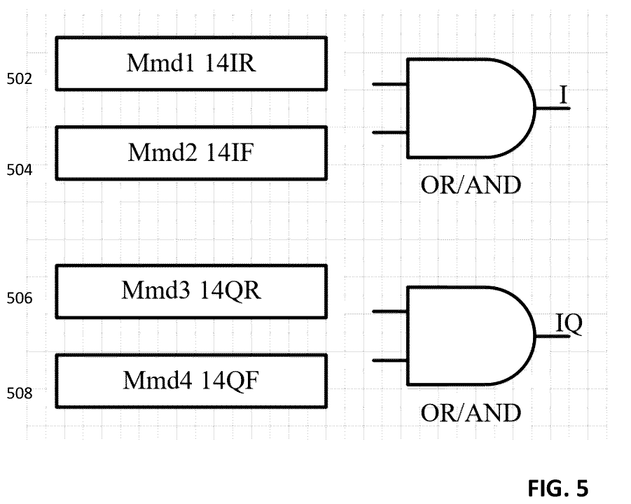

FIG. 5 depicts an alternative implementation in which the selectors are replaced by two additional MMDs, for a total of four MMDs. In this manner, two MMDs 502 and 504 operate with the 0/180 phase of the input clock (IR,IF), and two MMDs 506 and 508 operate on the 90/270 phase of the input clock (QR,QF). By selectively gating and choosing the output phase of each MMD, the required output signal with modulation from −90 to 180 degrees can be achieved and pass two phases to the following DCEI block.

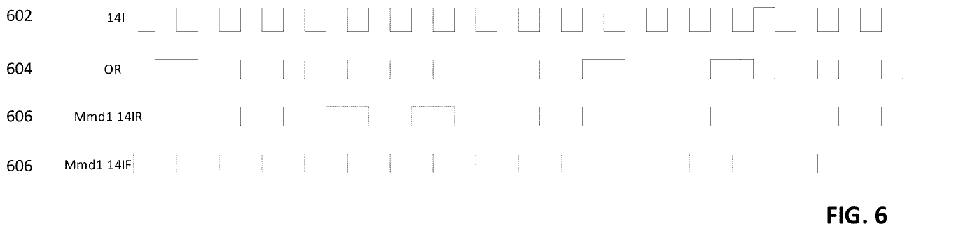

FIG. 6 depicts an example of the creation of signal “I” as depicted in FIG. 5. The output signal 602 is generated from the OR output 504 using the MMD1 506 signal and the MMD2 508 signal. In this figure, the output signal (OR) 604 has a nominal division of 2 and, in some cases, it is desired to expand this signal by 90/180 degrees and to compress the phase by 90 degrees. By allowing the phase of the MMD to always expand, the required signal can be realized by gating some of the pulses and the combining of their output using an OR gate.

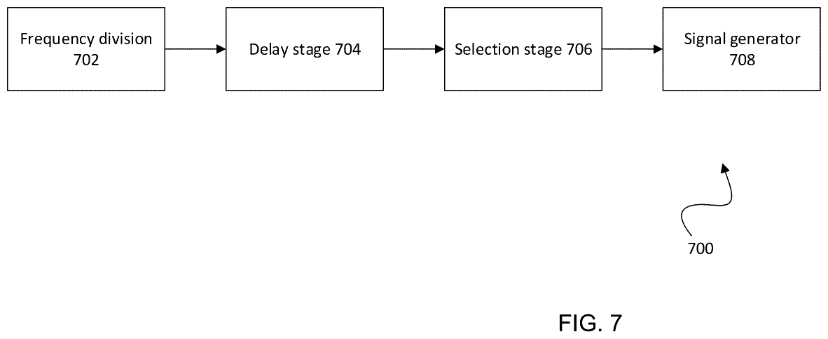

FIG. 7 depicts a DTC convertor 700. The DTC converter includes a frequency division stage 702, which is configured to generate a first frequency output based on a first instruction set and a second frequency output based on a second instruction set. The frequency division stage 702 may be implemented as to MMDs, which may be configured to generate signals based on a digital instruction or input. The instruction sets as described herein may be or include a code that corresponds to, or represents, a frequency to be generated by the MMD. The instruction set may be understood as an instruction code. The instruction set may be or include a code that corresponds to an instruction for any gate or gates as disclosed herein. The instruction set may be or include a signal, such as modulated to represent 0s or 1s, a data transmission, a high-level code representing instructions to be carried out by the MMD. The code may be generated or sent by a processor or controller. The MMDs may be configured to generate signals that are phase offset from one another by 90°. The MMDs may be configured to operate within the digital domain.

The DTC converter 700 further includes a delay stage 704, which is configured to generate a first delayed frequency output and a second delayed frequency output based on the first frequency output, and to generate a third delayed frequency output and a fourth delayed frequency output based on the second frequency output. The delay stage 704 may be implemented by four delay elements, wherein two delay elements are connected in series to process this signal of the first MMD, and two delay elements are connected in series to process the signal of the second MMD. Delay stages may be implemented with any of a variety of techniques. In some delay stages, the delay may be achieved by introducing an additional length of conductive path through which a signal may travel. In other delay stages, a delay may be achieved by processing an input signal through one or more circuits, such as one or more operational amplifiers or one or more other circuit devices that may introduce a delay through a switching operation (e.g. one or more transistors, etc.). The use of the term delay stage is intended to be generalized and therefore not limiting with respect to the method or manner in which the delay is introduced.

The DTC convertor 700 further includes a selection stage 706, which is configured to output one of the first delayed frequency output or the third delayed frequency output based on a control code; and to output one of the second delayed frequency output, the second frequency output, the first frequency output, or the fourth delayed frequency output based on the control code. The selection stage 706 may, in one configuration, be implemented as an array of gates that may be operated by a controller or processor (e.g. the DTC encoder of FIG. 2). In this manner, the gates may be configured to receive signals from the processor or controller, and in response to these signals, the gates may be configured to permit one or more input signals (e.g. one or more signals of the first MMD, the second MMD, or any of the delayed signals from the first MMD or the second MMD) to pass through the gate and be output as a gate output signal. The selection stage 706 may further include one or more logic gates (e.g. the four OR-gates depicted in FIG. 2) and/or one or more flip-flops, which may be used to store and stabilize a state received from a previous gate for providing a corresponding signal to an OR-gate and/or the DCEI. In an alternative configuration, the selection stage 706 may be implemented as a multiplexer, which may be configured to link one or more of said input signals with the DCEI.

The DTC converter 700 further includes a signal generator, which is configured to generate an interpolated signal based on the output of the selection stage. The signal generator 708 may be configured as a signal interpolator (e.g., as the DCEI of FIG. 2). In this manner, the signal generator 708 may be configured to receive two input signals and to interpolate the rising and/or falling edges of these receive signals to generate an output signal.

The DTC converter 700 may optionally include a processor. The processor may be configured to receive a phase code, and based on the phase code, to generate a first instruction to the frequency division stage to control the first frequency output and a second instruction to the frequency division stage to control the second frequency output. In this manner, the processor may perform some or all of the operations of the DTC encoder of FIG. 2.

The DTC converter 700 (and in particular, the frequency division stage) may optionally include a first frequency divider, configured to generate the first frequency output, and a second frequency divider, configured to generate the second frequency output. In this manner, the first frequency divider may be a multi-modulus frequency divider, and the second frequency divider may be a multi-modulus frequency divider. The first frequency divider may operate according to a first clock, and the second frequency divider may operate according to a second clock, different from the first clock. In this manner, the second frequency output may be phase offset 90 degrees from the first frequency output.

The signal generator may configured to generate the interpolated signal with one of a leading edge or a falling edge from one of the first frequency output, the first delayed frequency output or the second delayed frequency output, and another of the leading edge of the falling edge from one of the second frequency output, the third delayed frequency output or the fourth delayed frequency output.

The delay stage may include a first delay, which may be configured to generate a first delayed frequency output, wherein the first delayed frequency output is the first frequency output delayed by 45°; a second delay, configured to generate a second delayed frequency output, wherein the second delayed frequency output is the first frequency output delayed by 90°; a third delay, configured to generate a third delayed frequency output, wherein the third delayed frequency output is the second frequency output delayed by 45°; and a fourth delay, configured to generate a fourth delayed frequency output, wherein the fourth delayed frequency output is the second frequency output delayed by 90°.

The selection stage may include a first gate array, configured to receive the first frequency output, the first delayed frequency output or the second delayed frequency output; and a second gate array, configured to receive one of the second frequency output, the third delayed frequency output or the fourth delayed frequency output.

The selection stage may include a first gate array, which may be configured to receive the first frequency output, the first delayed frequency output or the second delayed frequency output. The selection stage may include a second gate array, which may be configured to receive one of the second frequency output, the third delayed frequency output or the fourth delayed frequency output. The processor may be further configured to generate a third instruction to control the first gate array and a fourth instruction to control the second gate array.

The DTC may further include a parallel-input serial-output unit, which may be configured to receive the first instruction, second instruction, third instruction, and the fourth instruction from the processor, and to output corresponding instructions to the frequency division stage, the first gate array, and the second gate array.

The selection stage may include a first OR-gate, configured to receive the first frequency output or the second frequency output. The first OR-gate may be configured to output a result of its OR logic function to the signal generator. The selection stage may further include a second OR-gate, a third OR-gate, and a fourth OR-gate. In this manner, the second OR-gate may be configured to receive an output of the third OR-gate and an output of the fourth OR-gate. The fourth OR-gate may be configured to output a result of its OR logic function to the signal generator. The third OR-gate may be configured to receive the first delayed frequency output and the third delayed frequency output. The fourth OR-gate may be configured to receive the second delayed frequency output and the fourth delayed frequency output.

The phase code as described herein may optionally include three bits. The processor may be configured to select the first frequency output for a leading edge of the interpolated signal if a middle bit of the three bits is 0, and to select the second frequency output for the leading edge of the interpolated signal based if the middle bit of the three bits is 1. The processor may be configured to control the selection stage to output the first frequency output and the first delayed frequency output or the second frequency output and the fourth delayed frequency output if a least significant bit of the three bits is 0. The processor may be configured to control the selection stage to output the first delayed frequency output and the second delayed frequency output or the third delayed frequency output and the fourth delayed frequency output if the least significant bit of the three bits is 1.

The frequency division stage may include a first frequency divider, which may be configured to generate the first frequency output. It may further include a second frequency divider, which may be configured to generate the second frequency output. It may further include a third frequency divider, which may be configured to generate a third frequency output. It may further include a fourth frequency divider, which may be configured to generate a fourth frequency output. In this manner, the second frequency output may have a phase that is 180 degrees different from a phase of the first frequency output. The fourth frequency output may have a phase that is 180 degrees different from a phase of the third frequency output. The phase of the fourth frequency output may be 90 degrees different from the phase of the second frequency output.

Further aspects of the disclosure will be described by way of example:

In Example 1, a digital to time convertor including: a frequency division stage, configured to generate a first frequency output based on a first instruction set and a second frequency output based on a second instruction set; a delay stage, configured to generate a first delayed frequency output and a second delayed frequency output based on the first frequency output, and to generate a third delayed frequency output and a fourth delayed frequency output based on the second frequency output; a selection stage, configured to output one of the first delayed frequency output or the third delayed frequency output based on a control code; and to output one of the second delayed frequency output, the second frequency output, the first frequency output, or the fourth delayed frequency output based on the control code; and a signal generator, configured to generate an interpolated signal based on the output of the selection stage.

In Example 2, the digital to time converter of Example 1, further including a processor, configured to receive a phase code, and based on the phase code, to generate a first instruction to the frequency division stage to control the first frequency output and a second instruction to the frequency division stage to control the second frequency output.

In Example 3, the digital to time converter of Example 1 or 2, wherein the frequency division stage includes a first frequency divider, configured to generate the first frequency output, and a second frequency divider, configured to generate the second frequency output.

In Example 4, the digital to time converter of Example 3, wherein the first frequency divider is a multi-modulus frequency divider, and wherein the second frequency divider is a multi-modulus frequency divider.

In Example 5, the digital to time converter of Example 3 or 4, wherein the first frequency divider operates according to a first clock, and wherein the second frequency divider operates according to a second clock, different from the first clock.

In Example 6, the digital to time converter of any one of Examples 1 to 5, wherein the second frequency output is phase offset 90 degrees from the first frequency output.

In Example 7, the digital to time converter of any one of Examples 1 to 6, wherein the signal generator is configured to generate the interpolated signal with one of a leading edge or a falling edge from one of the first frequency output, the first delayed frequency output or the second delayed frequency output, and another of the leading edge of the falling edge from one of the second frequency output, the third delayed frequency output or the fourth delayed frequency output.

In Example 8, the digital to time converter of any one of Examples 1 to 7, wherein the delay stage includes: a first delay, configured to generate a first delayed frequency output, wherein the first delayed frequency output is the first frequency output delayed by 45°; a second delay, configured to generate a second delayed frequency output, wherein the second delayed frequency output is the first frequency output delayed by 90°; a third delay, configured to generate a third delayed frequency output, wherein the third delayed frequency output is the second frequency output delayed by 45°; and a fourth delay, configured to generate a fourth delayed frequency output, wherein the fourth delayed frequency output is the second frequency output delayed by 90°.

In Example 9, the digital to time converter of any one of Examples 1 to 8, wherein the selection stage includes a first gate array, configured to receive the first frequency output, the first delayed frequency output or the second delayed frequency output; and a second gate array, configured to receive one of the second frequency output, the third delayed frequency output or the fourth delayed frequency output.

In Example 10, the digital to time converter of any one of Examples 2 to 9, wherein the selection stage includes a first gate array, configured to receive the first frequency output, the first delayed frequency output or the second delayed frequency output; and a second gate array, configured to receive one of the second frequency output, the third delayed frequency output or the fourth delayed frequency output; and wherein the processor is further configured to generate a third instruction to control the first gate array and a fourth instruction to control the second gate array.

In Example 11, the digital to time converter of Example 10, further including a parallel-input serial-output unit, configured to receive the first instruction, second instruction, third instruction, and the fourth instruction from the processor, and to output corresponding instructions to the frequency division stage, the first gate array, and the second gate array.

In Example 12, the digital to time converter of any one of Examples 1 to 11, wherein the selection stage further includes a first OR-gate, configured to receive the first frequency output or the second frequency output, and wherein the first OR-gate is configured to output a result of its OR logic function to the signal generator.

In Example 13, the digital to time converter of Example 12, wherein the selection stage further includes a second OR-gate, a third OR-gate, and a fourth OR-gate; wherein the second OR-gate is configured to receive an output of the third OR-gate and an output of the fourth OR-gate, and wherein the fourth OR-gate is configured to output a result of its OR logic function to the signal generator; wherein the third OR-gate is configured to receive the first delayed frequency output and the third delayed frequency output; and wherein the fourth OR-gate is configured to receive the second delayed frequency output and the fourth delayed frequency output.

In Example 14, the digital to time converter of any one of Examples 2 to 13, wherein the phase code includes three bits; and wherein the processor is configured to select the first frequency output for a leading edge of the interpolated signal if a middle bit of the three bits is 0, and to select the second frequency output for the leading edge of the interpolated signal based if the middle bit of the three bits is 1.

In Example 15, the digital to time converter of any one of Examples 2 to 14, wherein the phase code includes three bits; wherein the processor is configured to control the selection stage to output the first frequency output and the first delayed frequency output or the second frequency output and the fourth delayed frequency output if a least significant bit of the three bits is 0; and wherein the processor is configured to control the selection stage to output the first delayed frequency output and the second delayed frequency output or the third delayed frequency output and the fourth delayed frequency output if the least significant bit of the three bits is 1.

In Example 16, the digital to time converter of any one of Examples 1 to 15, wherein the frequency division stage includes a first frequency divider, configured to generate the first frequency output; a second frequency divider, configured to generate the second frequency output; a third frequency divider, configured to generate a third frequency output; and a fourth frequency divider, configured to generate a fourth frequency output; wherein the second frequency output has a phase that is 180 degrees different from a phase of the first frequency output; wherein the fourth frequency output has a phase that is 180 degrees different from a phase of the third frequency output; and wherein the phase of the fourth frequency output is 90 degrees different from the phase of the second frequency output.

In Example 17, a digital to time convertor including: a frequency division means for generating a first frequency output based on a first instruction set and a second frequency output based on a second instruction set; a delay means for generating a first delayed frequency output and a second delayed frequency output based on the first frequency output, and for generating a third delayed frequency output and a fourth delayed frequency output based on the second frequency output; a selection means for outputting one of the first delayed frequency output or the third delayed frequency output based on a control code; and for outputting one of the second delayed frequency output, the second frequency output, the first frequency output, or the fourth delayed frequency output based on the control code; and a signal generator, for generating an interpolated signal based on the output of the selection means.

In Example 18, the digital to time converter of Example 17, further including a processor for receiving a phase code, and based on the phase code, generating a first instruction to the frequency division means to control the first frequency output and a second instruction to the frequency division means to control the second frequency output.

In Example 19, the digital to time converter of Example 17 or 18, wherein the frequency division means includes a first frequency divider for generating the first frequency output, and a second frequency divider for generating the second frequency output.

In Example 20, the digital to time converter of Example 19, wherein the first frequency divider is a multi-modulus frequency divider, and wherein the second frequency divider is a multi-modulus frequency divider.

In Example 21, the digital to time converter of Example 19 or 20, wherein the first frequency divider operates according to a first clock, and wherein the second frequency divider operates according to a second clock, different from the first clock.

In Example 22, the digital to time converter of any one of Examples 17 to 21, wherein the second frequency output is phase offset 90 degrees from the first frequency output.

In Example 23, the digital to time converter of any one of Examples 17 to 22, wherein the signal generator is for generating the interpolated signal with one of a leading edge or a falling edge from one of the first frequency output, the first delayed frequency output or the second delayed frequency output, and another of the leading edge of the falling edge from one of the second frequency output, the third delayed frequency output or the fourth delayed frequency output.

In Example 24, the digital to time converter of any one of Examples 17 to 23, wherein the delay means includes: a first delay for generating a first delayed frequency output, wherein the first delayed frequency output is the first frequency output delayed by 45°; a second delay for generating a second delayed frequency output, wherein the second delayed frequency output is the first frequency output delayed by 90°; a third delay for generating a third delayed frequency output, wherein the third delayed frequency output is the second frequency output delayed by 45°; and a fourth delay for generating a fourth delayed frequency output, wherein the fourth delayed frequency output is the second frequency output delayed by 90°.

In Example 25, the digital to time converter of any one of Examples 17 to 24, wherein the selection means includes a first gate array for receiving the first frequency output, the first delayed frequency output or the second delayed frequency output; and a second gate array for receiving one of the second frequency output, the third delayed frequency output or the fourth delayed frequency output.

In Example 26, the digital to time converter of any one of Examples 18 to 25, wherein the selection means includes a first gate array for receiving the first frequency output, the first delayed frequency output or the second delayed frequency output; and a second gate array for receiving one of the second frequency output, the third delayed frequency output or the fourth delayed frequency output; and wherein the processor is for generating a third instruction to control the first gate array and a fourth instruction to control the second gate array.

In Example 27, the digital to time converter of Example 26, further including a parallel-input serial-output unit for receiving the first instruction, second instruction, third instruction, and the fourth instruction from the processor, and for outputting corresponding instructions to the frequency division means, the first gate array, and the second gate array.

In Example 28, the digital to time converter of any one of Examples 17 to 27, wherein the selection means further includes a first OR-gate for receiving the first frequency output or the second frequency output, and wherein the first OR-gate is configured to output a result of its OR logic function to the signal generator.

In Example 29, the digital to time converter of Example 28, wherein the selection means further includes a second OR-gate, a third OR-gate, and a fourth OR-gate; wherein the second OR-gate is for receiving an output of the third OR-gate and an output of the fourth OR-gate, and wherein the fourth OR-gate is for outputting a result of its OR logic function to the signal generator; wherein the third OR-gate is for receiving the first delayed frequency output and the third delayed frequency output; and wherein the fourth OR-gate is for receiving the second delayed frequency output and the fourth delayed frequency output.

In Example 30, the digital to time converter of any one of Examples 18 to 29, wherein the phase code includes three bits; and wherein the processor is for selecting the first frequency output for a leading edge of the interpolated signal if a middle bit of the three bits is 0, and selecting the second frequency output for the leading edge of the interpolated signal based if the middle bit of the three bits is 1.

In Example 31, the digital to time converter of any one of Examples 18 to 30, wherein the phase code includes three bits; wherein the processor is for controlling the selection means to output the first frequency output and the first delayed frequency output or the second frequency output and the fourth delayed frequency output if a least significant bit of the three bits is 0; and wherein the processor is for controlling the selection means to output the first delayed frequency output and the second delayed frequency output or the third delayed frequency output and the fourth delayed frequency output if the least significant bit of the three bits is 1.

In Example 32, the digital to time converter of any one of Examples 17 to 31, wherein the frequency division means includes a first frequency divider for generating the first frequency output; a second frequency divider for generating the second frequency output; a third frequency divider, for generating a third frequency output; and a fourth frequency divider for generating a fourth frequency output; wherein the second frequency output has a phase that is 180 degrees different from a phase of the first frequency output; wherein the fourth frequency output has a phase that is 180 degrees different from a phase of the third frequency output; and wherein the phase of the fourth frequency output is 90 degrees different from the phase of the second frequency output.

In Example 33, a method of digital to time conversion including: generating a first frequency output based on a first instruction set and a second frequency output based on a second instruction set; generating a first delayed frequency output and a second delayed frequency output based on the first frequency output, and generating a third delayed frequency output and a fourth delayed frequency output based on the second frequency output; outputting one of the first delayed frequency output or the third delayed frequency output based on a control code; and outputting one of the second delayed frequency output, the second frequency output, the first frequency output, or the fourth delayed frequency output based on the control code; and generating an interpolated signal based on the output of the selection stage.

In Example 34, the method of Example 33, further including receiving a phase code, and based on the phase code, generating a first instruction to the frequency division stage to control the first frequency output and a second instruction to the frequency division stage to control the second frequency output.

In Example 35, the method of Example 33 or 34, further including generating the first frequency output, and a second frequency divider, configured to generate the second frequency output.

In Example 36, the method of any one of Examples 33 to 35, wherein the second frequency output is phase offset 90 degrees from the first frequency output.

In Example 37, the method of any one of Examples 33 to 36, further including generating the interpolated signal with one of a leading edge or a falling edge from one of the first frequency output, the first delayed frequency output or the second delayed frequency output, and another of the leading edge of the falling edge from one of the second frequency output, the third delayed frequency output or the fourth delayed frequency output.

In Example 38, the method of any one of Examples 33 to 37, wherein the delay stage includes: generating a first delayed frequency output, wherein the first delayed frequency output is the first frequency output delayed by 45°; generating a second delayed frequency output, wherein the second delayed frequency output is the first frequency output delayed by 90°; generating a third delayed frequency output, wherein the third delayed frequency output is the second frequency output delayed by 45°; and generating a fourth delayed frequency output, wherein the fourth delayed frequency output is the second frequency output delayed by 90°.

In Example 39, the method of Example 38, further including receiving the first instruction, second instruction, third instruction, and the fourth instruction, and outputting corresponding instructions to the frequency division stage, the first gate array, and the second gate array.

In Example 40, the method of any one of Examples 33 to 39, further including receiving the first frequency output or the second frequency output, and outputting a result of its OR logic function to the signal generator.

In Example 41, the method of any one of Examples 34 to 40, wherein the phase code includes three bits; and further including selecting the first frequency output for a leading edge of the interpolated signal if a middle bit of the three bits is 0, and selecting the second frequency output for the leading edge of the interpolated signal based if the middle bit of the three bits is 1.

In Example 42, the method of any one of Examples 34 to 41, wherein the phase code includes three bits; further including controlling the selection stage to output the first frequency output and the first delayed frequency output or the second frequency output and the fourth delayed frequency output if a least significant bit of the three bits is 0; and controlling the selection stage to output the first delayed frequency output and the second delayed frequency output or the third delayed frequency output and the fourth delayed frequency output if the least significant bit of the three bits is 1.

In Example 43, the method of any one of Examples 33 to 42, further including generating the first frequency output; generating the second frequency output; generating a third frequency output; and generating a fourth frequency output; wherein the second frequency output has a phase that is 180 degrees different from a phase of the first frequency output; wherein the fourth frequency output has a phase that is 180 degrees different from a phase of the third frequency output; and wherein the phase of the fourth frequency output is 90 degrees different from the phase of the second frequency output.

While the above descriptions and connected figures may depict components as separate elements, skilled persons will appreciate the various possibilities to combine or integrate discrete elements into a single element. Such may include combining two or more circuits for form a single circuit, mounting two or more circuits onto a common chip or chassis to form an integrated element, executing discrete software components on a common processor core, etc. Conversely, skilled persons will recognize the possibility to separate a single element into two or more discrete elements, such as splitting a single circuit into two or more separate circuits, separating a chip or chassis into discrete elements originally provided thereon, separating a software component into two or more sections and executing each on a separate processor core, etc.

It is appreciated that implementations of methods detailed herein are demonstrative in nature, and are thus understood as capable of being implemented in a corresponding device. Likewise, it is appreciated that implementations of devices detailed herein are understood as capable of being implemented as a corresponding method. It is thus understood that a device corresponding to a method detailed herein may include one or more components configured to perform each aspect of the related method.

All acronyms defined in the above description additionally hold in all claims included herein.

What is claimed is:

1. A digital to time convertor comprising:
a frequency division stage, configured to generate a first frequency output based on a first instruction set and a second frequency output based on a second instruction set;
a delay stage, configured to generate a first delayed frequency output and a second delayed frequency output based on the first frequency output, and to generate a third delayed frequency output and a fourth delayed frequency output based on the second frequency output;
a selection stage, configured to generate one of the first delayed frequency output or the third delayed frequency output based on a control code; and to output one of the second delayed frequency output, the second frequency output, the first frequency output, or the fourth delayed frequency output based on the control code; and
a signal generator, configured to generate an interpolated signal based on the output of the selection stage.

2. The digital to time converter of claim 1, further comprising a processor, configured to receive a phase code, and based on the phase code, to generate a first instruction to the frequency division stage to control the first frequency output and a second instruction to the frequency division stage to control the second frequency output.

3. The digital to time converter of claim 1, wherein the frequency division stage comprises a first frequency divider, configured to generate the first frequency output, and a second frequency divider, configured to generate the second frequency output.

4. The digital to time converter of claim 3, wherein the first frequency divider is a multi-modulus frequency divider, and wherein the second frequency divider is a multi-modulus frequency divider.

5. The digital to time converter of claim 3, wherein the first frequency divider operates according to a first clock, and wherein the second frequency divider operates according to a second clock, different from the first clock.

6. The digital to time converter of claim 1, wherein the second frequency output is phase offset 90 degrees from the first frequency output.

7. The digital to time converter of claim 1, wherein the signal generator is configured to generate the interpolated signal with one of a leading edge or a falling edge from one of the first frequency output, the first delayed frequency output or the second delayed frequency output, and another of the leading edge of the falling edge from one of the second frequency output, the third delayed frequency output or the fourth delayed frequency output.

8. The digital to time converter of claim 1, wherein the delay stage comprises:
a first delay, configured to generate a first delayed frequency output, wherein the first delayed frequency output is the first frequency output delayed by 45°;
a second delay, configured to generate a second delayed frequency output, wherein the second delayed frequency output is the first frequency output delayed by 90°;
a third delay, configured to generate a third delayed frequency output, wherein the third delayed frequency output is the second frequency output delayed by 45°; and
a fourth delay, configured to generate a fourth delayed frequency output, wherein the fourth delayed frequency output is the second frequency output delayed by 90°.

9. The digital to time converter of claim 1, wherein the selection stage comprises a first gate array, configured to receive the first frequency output, the first delayed frequency output or the second delayed frequency output; and a second gate array, configured to receive one of the second frequency output, the third delayed frequency output or the fourth delayed frequency output.

10. The digital to time converter of claim 2, wherein the selection stage comprises a first gate array, configured to receive the first frequency output, the first delayed frequency output or the second delayed frequency output; and a second gate array, configured to receive one of the second frequency output, the third delayed frequency output or the fourth delayed frequency output; and wherein the processor is further configured to generate a third instruction to control the first gate array and a fourth instruction to control the second gate array.

11. The digital to time converter of claim 10, further comprising a parallel-input serial-output unit, configured to receive the first instruction, second instruction, third instruction, and the fourth instruction from the processor, and to output corresponding instructions to the frequency division stage, the first gate array, and the second gate array.

12. The digital to time converter of claim 1, wherein the selection stage further comprises a first OR-gate, configured to receive the first frequency output or the second frequency output, and wherein the first OR-gate is configured to output a result of its OR logic function to the signal generator.

13. The digital to time converter of claim 12, wherein the selection stage further comprises a second OR-gate, a third OR-gate, and a fourth OR-gate; wherein the second OR-gate is configured to receive an output of the third OR-gate and an output of the fourth OR-gate, and wherein the fourth OR-gate is configured to output a result of its OR logic function to the signal generator; wherein the third OR-gate is configured to receive the first delayed frequency output and the third delayed frequency output; and wherein the fourth OR-gate is configured to receive the second delayed frequency output and the fourth delayed frequency output.

14. The digital to time converter of claim 2, wherein the phase code comprises three bits; and wherein the processor is configured to select the first frequency output for a leading edge of the interpolated signal if a middle bit of the three bits is 0, and to select the second frequency output for the leading edge of the interpolated signal based if the middle bit of the three bits is 1.

15. The digital to time converter of claim 2, wherein the phase code comprises three bits; wherein the processor is configured to control the selection stage to output the first frequency output and the first delayed frequency output or the second frequency output and the fourth delayed frequency output if a least significant bit of the three bits is 0; and wherein the processor is configured to control the selection stage to output the first delayed frequency output and the second delayed frequency output or the third delayed frequency output and the fourth delayed frequency output if the least significant bit of the three bits is 1.

16. The digital to time converter of claim 1, wherein the frequency division stage comprises a first frequency divider, configured to generate the first frequency output; a second frequency divider, configured to generate the second frequency output; a third frequency divider, configured to generate a third frequency output; and a fourth frequency divider, configured to generate a fourth frequency output; wherein the second frequency output has a phase that is 180 degrees different from a phase of the first frequency output; wherein the fourth frequency output has a phase that is 180 degrees different from a phase of the third frequency output; and wherein the phase of the fourth frequency output is 90 degrees different from the phase of the second frequency output.

3. A digital to time convertor comprising:
a frequency division means for generating a first frequency output based on a first instruction set and a second frequency output based on a second instruction set;
a delay means for generating a first delayed frequency output and a second delayed frequency output based on the first frequency output, and for generating a third delayed frequency output and a fourth delayed frequency output based on the second frequency output;
a selection means for outputting one of the first delayed frequency output or the third delayed frequency output based on a control code, and for outputting one of the second delayed frequency output, the second frequency output, the first frequency output, or the fourth delayed frequency output based on the control code; and
a signal generator, for generating an interpolated signal based on the output of the selection means.

18. The digital to time converter of claim 17, further comprising a processor for receiving a phase code, and based on the phase code, generating a first instruction to the frequency division means to control the first frequency output and a second instruction to the frequency division means to control the second frequency output.

4. A method of digital to time conversion comprising:
generating a first frequency output based on a first instruction set and a second frequency output based on a second instruction set;
generating a first delayed frequency output and a second delayed frequency output based on the first frequency output, and generating a third delayed frequency output and a fourth delayed frequency output based on the second frequency output;
outputting one of the first delayed frequency output or the third delayed frequency output based on a control code; and
outputting one of the second delayed frequency output, the second frequency output, the first frequency output, or the fourth delayed frequency output based on the control code; and
generating an interpolated signal based on the outputting.

20. The method of claim 19, further comprising:
receiving a phase code, and
based on the phase code, generating a first instruction to control the first frequency output and a second instruction to control the second frequency output.
